(19) United States
(12) Patent Application Publication
(10) Pub. No.: US 2005/0151546 A1
(43) Pub. Date: Jul. 14, 2005

(54) Electrically-based fluid corrosion/erosion protection apparatus and associated methods

(76) Inventor: Bruce E. Taber, Bothell, WA (US)

Correspondence Address: KONNEKER & SMITH P. C., 660 NORTH CENTRAL EXPRESSWAY, SUITE 230, PLANO, TX, 75074, US

(21) Appl. No.: 10/753,595

(22) Filed: Jan. 8, 2004

(51) Int. Cl. G01N 27/00

(52) U.S. Cl. 324/700; 324/71.2; 205/775.5

(57) ABSTRACT

The interior of a vessel containing fluid is protected against undesirable chemical corrosion and/or mechanical erosion caused by the fluid due, for example, to changes in the chemistry of the fluid, by an electrically conductive, chemically corrodable sacrificial member having an internal section disposed within the tank and an exposed exterior portion connected to an electrical corrosion/erosion detection circuit operative to create and maintain a flow of electrical current through the sacrificial member. When the internal section of the sacrificial member is subjected to a predetermined combination of fluid exposure time and fluid chemical corrosivity within the vessel a chemical corrosion gap is formed within the internal sacrificial member section. Creation of this gap terminates or at least substantially reduces electrical current flow through the sacrificial member and responsively causes the detection circuit to output a corrosion/erosion detection signal indicating the need for corrective action.

### BACKGROUND OF THE INVENTION

The present invention generally relates to protecting fluid containing vessels from chemical corrosion and/or mechanical erosion by fluid disposed therein and, in an illustrated embodiment thereof, more particularly provides specially designed pressure-based chemical corrosion/mechanical erosion monitoring and protection apparatus and associated methods for such vessels.

Fluid-containing vessels, such as tanks and the like, are often susceptible to internal chemical corrosion and/or mechanical erosion damage, and corresponding premature failure when the chemical corrosivity level of the fluid which they contain increases. For example, water chemistry is known to attack boiler, water heater and chiller tank materials, with the result that the tanks, and associated fluid system materials, can prematurely deteriorate.

Various proposals have previously been made for monitoring corrosion of a sacrificial member disposed in fluid contained within a vessel and automatically generating a protective corrosion detection output signal. Generation of this corrosion detection signal permits suitable maintenance to be performed prior to premature corrosion damage to the vessel. A primary disadvantage of many of these previously proposed corrosion detection systems has been their structural and/or fabricational complexity which undesirably increases their overall costs.

A need thus exists for a simpler, less expensive technique for monitoring a vessel and protecting it from chemical corrosivity of fluid which it contains. It is to this need that the present invention is directed.

### SUMMARY OF THE INVENTION

In carrying out principles of the present invention, in accordance with a representatively illustrated embodiment thereof, a vessel adapted to contain a quantity of fluid is provided with specially designed corrosion/erosion protection apparatus and associated methods which detect a predetermined chemical corrosivity level in the fluid (created, for example, by a change in its chemistry during operation of a system in which the vessel is incorporated) and responsively generates a corrosion/erosion detection signal.

In a representative embodiment thereof, the corrosion/erosion protection apparatus comprises at least one electrically conductive sacrificial structure having a section communicatable with the interior of the vessel and having first and second portions, the section being constructed and configured to be chemically corroded by vessel fluid, to an extent creating an electrically nonconductive gap between the first and second portions, in response to exposure of the sacrificial structure section to a predetermined combination of fluid exposure time and fluid chemical corrosivity. The corrosion/erosion protection apparatus also includes an electrical corrosion/erosion detection circuit operative to flow electrical current through the immersed section of the sacrificial structure between the first and second portions thereof and, in response to the creation of the nonconductive gap and a resultant cessation or other predetermined reduction of electrical current flow through the section, being operative to output a corrosion/erosion detection signal indicating a need for appropriate corrective action to be taken.

Illustratively, the sacrificial structure is an elongated strip of electrically conductive, chemically corrodable material having a generally U-shaped configuration with a closed end portion from which a spaced pair of elongated parallel legs extend. The legs are imbedded within a dielectric material filling the interior of a generally tubular connection member threaded into an opening in the vessel. The closed end of the sacrificial member is immersed in the fluid, and outer end portions of the legs are positioned externally of the vessel and operatively connected to the corrosion detection circuit. A part of the closed end portion of the sacrificial member may be cross-sectionally narrowed to facilitate the formation of the corrosion gap therein. When the corrosion gap is formed in the immersed section of the sacrificial member, further electrical current flow through the sacrificial member is prevented or at least substantially reduced. In response to this gap-created cessation or reduction of electrical current flow through the sacrificial member, the corrosion detection circuit automatically outputs the aforementioned corrosion/erosion detection signal.

The corrosion protection system of the present invention is of a simple, inexpensive and reliable construction in which the sacrificial member provides the dual functions of directly detecting an unacceptable chemical corrosivity level within the vessel and, via a corrosion-created prevention of electrical current flow therethrough, directly triggering the responsive corrosion detection signal.

### BRIEF DESCRIPTION OF THE DRAWINGS

FIG. 1 is a schematic cross-sectional view through a portion of a fluid-containing vessel having associated therewith specially designed electrically-based corrosion/erosion protection apparatus embodying principles of the present invention;

FIG. 2 is a cross-sectional view through a vessel insert portion of the corrosion/erosion protection apparatus taken along line 2-2 of FIG. 1;

FIG. 3 is a bottom end view of a sacrificial insert member taken along line 3-3 of FIG. 1, the sacrificial insert member being in an initial, uncorroded condition; and

FIG. 3A is a view similar to that in FIG. 3, but with the sacrificial insert member being in a corroded, circuit-opening condition.

### DETAILED DESCRIPTION

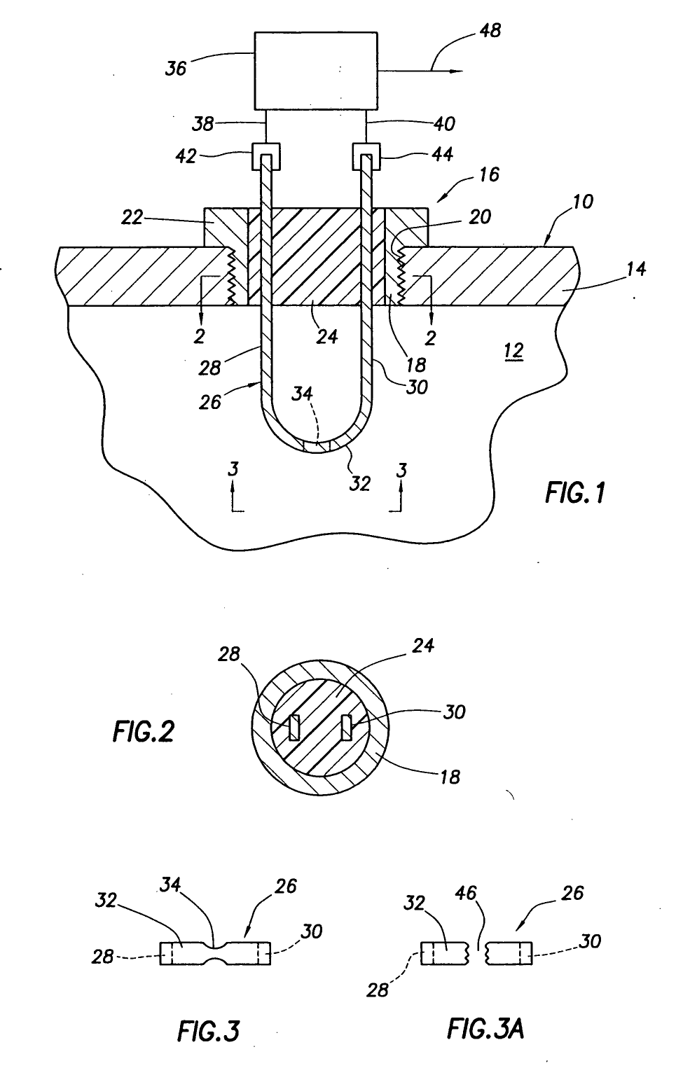

Schematically depicted in FIG. 1 is an illustrative vessel 10 adapted to hold a fluid 12, which may be pressurized or unpressurized, and having a chemically corrodable outer wall 14. The fluid 12 may be a liquid, such as water, or a gas, and the vessel 10 may representatively, but not by way of limitation, be a metal tank of the type used in water heaters, boilers, chillers or the like.

Operatively associated with the vessel 10, and embodying principles of the present invention, is specially designed protective apparatus 16 for protecting the vessel 10 against chemical corrosion and/or mechanical corrosion of the interior surface of its outer wall 14 by the fluid 12 within the vessel 10 in the event that the chemical corrosivity of the fluid 12 becomes undesirably high.

The protective apparatus 16 includes a generally tubular metal connection member 18 sealingly threaded into an opening 20 in the outer vessel wall 14 and having an outer flange portion 22. Sealingly anchored within the interior of the connection member 18 is a dielectric material 24. A generally U-shaped sacrificial member 26, formed from a chemically corrodable material such as copper or another metal, has opposite leg portions 28,30 sealingly extending through and projecting upwardly beyond the dielectric material 24 (see FIG. 2), and a closed lower end section 32 (see FIGS. 1 and 3) spaced downwardly apart from the connection member 18 and disposed within the interior of the vessel 10. Alternatively, the closed lower end section 32 could be communicated with the interior of the vessel 10 by, for example, placing the section 32 in a conduit exterior to the vessel 10 and communicating with its interior.

Representatively, the sacrificial member 26 has a strip-like configuration with an elongated rectangular cross-section along its length. If desired, the sacrificial member 26 could be provided with a variety of other shapes and cross-sections without departing from principles of the present invention. Illustratively, as shown in FIG. 3, the lower end section 32 of the sacrificial member 26 has a narrowed portion 34 formed therein. However, depending on the overall design of the protective apparatus 16, this narrowed portion may be omitted from the sacrificial member if desired.

The protective apparatus 16 also includes a corrosion/erosion monitoring electrical circuit 36 (see FIG. 3) electrically coupled to the upper ends of the sacrificial member legs 28,30 by electrical leads 38,40 and associated connector structures 42,44. Monitoring circuit 36 is operative to create and maintain a flow of electrical current through the sacrificial member 26 between its opposite legs 28,30 via the closed lower end section 32 of the sacrificial member 26.

Sacrificial member 26 is constructed and configured (as to its material and the cross-sectional area of its narrowed portion 34) in a manner such that the narrowed portion 34 will corrode through, to thereby create an electrically nonconductive gap 46 between facing portions of the lower end section 32 as shown in FIG. 3A, in response to a predetermined combination for the sacrificial member 26 of fluid exposure time and fluid chemical corrosivity correlated to a predetermined amount of chemical corrosion and/or mechanical erosion by the fluid 12 of the interior of the vessel 10.

The chemical corrosion-created gap 46 in the sacrificial member 26 prevents or at least substantially reduces further electrical current flow therethrough between facing portions of the lower end section 32, thereby correspondingly terminating or reducing the electrical current flow through the sacrificial member 26 previously created and maintained by the electrical monitoring circuit 36. Circuit 36 is operative to detect this predetermined reduction of electrical current flow through the sacrificial member 26 and responsively output a corrosion/erosion detection signal 48 (see FIG. 1) giving an indication that corrective action needs to be taken due to a chemical corrosion and/or mechanical erosion problem within the vessel 10.

As can readily be seen, the corrosion/erosion protection system 16 is of a simple, inexpensive and reliable construction in which the sacrificial member 26 provides the dual functions of directly detecting an unacceptable chemical corrosivity level within the vessel 10 and, via a corrosion-created prevention or reduction of electrical current flow therethrough, directly triggering the responsive corrosion detection signal 48. While the corrosion/erosion protection system 16 has been representatively depicted as utilizing a single sacrificial member 26, it will be readily appreciated by those of ordinary skill in this particular art that one or more additional sacrificial members 26 (not shown) could be operatively coupled to the circuit 36 to provide the system 16 with corrosion/erosion detection redundancy if desired.

The foregoing detailed description is to be clearly understood as being given by way of illustration and example only, the spirit and scope of the present invention being limited solely by the appended claims.

1. Apparatus for protecting a vessel against chemical corrosion and/or mechanical erosion thereof by a fluid therein, said apparatus comprising:
an electrically conductive sacrificial structure having a section communicatable with the interior of the vessel and having first and second portions, said section being constructed and configured to be chemically corroded by vessel fluid, to an extent creating a gap between said first and second portions, in response to exposure of said section to a predetermined combination of fluid exposure time and fluid chemical corrosivity; and
an electrical corrosion/erosion detection circuit operative to flow electrical current through said section of said sacrificial structure between said first and second portions thereof and, in response to the creation of said gap and a resultant predetermined reduction of electrical current flow through said section, being operative to output a corrosion/erosion detection signal.

2. The apparatus of claim 1 wherein:
said section has a cross-sectionally narrowed portion operative to facilitate the formation of said gap therein.

3. The apparatus of claim 1 wherein:
said sacrificial structure has a strip-shaped configuration.

4. The apparatus of claim 1 wherein:
said sacrificial structure is formed from a metal material.

5. The apparatus of claim 1 wherein:
said sacrificial structure is a generally U-shaped sacrificial member formed from an electrically conductive, chemically corrodable material and having a closed end portion at least partially defining said section positionable in the interior of the vessel.

6. The apparatus of claim 5 wherein:
said sacrificial member has a spaced apart opposite pair of generally parallel legs with outer end portions, and said apparatus further comprises a hollow, generally tubular connection member threadable into an opening in the vessel and having a dielectric material disposed within the interior of said connection member, said legs being imbedded in said dielectric material, and said outer leg end portions being exposed for operative connection to said electrical corrosion/erosion detection circuit.

7. Fluid containment apparatus comprising:
a vessel adapted to contain a fluid; and
corrosion/erosion protection apparatus for protecting said vessel from chemical corrosion and/or mechanical erosion by fluid disposed within said vessel, said corrosion/erosion protection apparatus including:
an electrically conductive sacrificial structure having a section communicated with the interior of said vessel and having first and second portions, said section being constructed and configured to be chemically corroded by fluid in said vessel, to an extent creating a gap between said first and second portions, in response to exposure of said section to a predetermined combination of fluid exposure time and fluid chemical corrosivity; and
an electrical corrosion/erosion detection circuit connected to said sacrificial member and operative to flow electrical current through said section of said sacrificial structure between said first and second portions thereof and, in response to the creation of said and a resultant predetermined reduction of electrical current flow through said section, being operative to output a corrosion/erosion detection signal.

8. The fluid containment apparatus of claim 7 wherein:
said section has a cross-sectionally narrowed portion operative to facilitate the formation of said gap therein.

9. The fluid containment apparatus of claim 7 wherein:
said sacrificial structure has a strip-shaped configuration.

10. The fluid containment apparatus of claim 7 wherein:
said sacrificial structure is formed from a metal material.

11. The fluid containment apparatus of claim 7 wherein:
said sacrificial structure is a generally U-shaped sacrificial member formed from an electrically conductive, chemically corrodable material and having a closed end portion at least partially defining said section.

12. The fluid containment apparatus of claim 11 wherein:
said sacrificial member has a spaced apart opposite pair of generally parallel legs with outer end portions, and
said apparatus further comprises a hollow, generally tubular connection member received in an opening in said vessel and having a dielectric material disposed within the interior of said connection member, said legs being imbedded in said dielectric material, said outer leg end portions being disposed externally of said vessel and operatively connected to said electrical corrosion detection circuit, and said section being disposed within the interior of said vessel.

13. A method of protecting a vessel from chemical corrosion and/or mechanical erosion by a fluid disposed therein, said method comprising the steps of:
communicating a section of an electrically conductive sacrificial member with the interior of the vessel, said section having first and second portions and being constructed and configured to be chemically corroded by fluid in said vessel, to an extent creating a gap between said first and second portions, in response to exposure of said section to a predetermined combination of fluid exposure time and fluid chemical corrosivity;
flowing electrical current between said first and second portions of said section of said sacrificial member; and
generating a corrosion/erosion detection signal in response to a predetermined reduction in electrical flow between said first and second portions caused by the creation of said gap.
